(19) United States
(12) Patent Application Publication
(10) Pub. No.: US 2014/0046676 A1
(43) Pub. Date: Feb. 13, 2014

(54) IMAGE-BASED VALIDATION SYSTEM FOR PRESCRIPTION FULFILLMENT

(71) Applicants: Wendell Lewis Kibler, Rochester, NY (US); Paul R. Austin, Webster, NY (US)

(72) Inventors: Wendell Lewis Kibler, Rochester, NY (US); Paul R. Austin, Webster, NY (US)

(73) Assignee: XEROX CORPORATION, Norwalk, CT (US)

(21) Appl. No.: 13/571,820

(22) Filed: Aug. 10, 2012

(51) Int. Cl. G06Q 50/22; G06K 9/62

(52) U.S. Cl. 705/2

(57) ABSTRACT

A method of verifying fulfillment of a prescription may include receiving an image of a personalized medication package associated with a patient, receiving a patient identifier associated with the patient, and using the patient identifier to identify a medication regimen for the patient. The method may include analyzing the image to identify at least one pill, and for each identified pill, determining one or more physical features of the pill, determining a location of the pill with respect to the personalized medication package, determining whether the determined location of the pill is correct based on the determined physical features and the medication regimen, and in response to determining that the determined location of the pill is not accurate, generating an alert.

### BACKGROUND

Low rates of adherence to prescribed medication regimens can jeopardize treatment effectiveness. In addition, medication regimens are becoming complex due to a number of factors, including for example, the number of different prescribing physicians and the number of different medications being prescribed.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In an embodiment, a method of verifying fulfillment of a prescription may include receiving, by a computing device, an image of a personalized medication package associated with a patient, receiving, by the computing device, a patient identifier associated with the patient, and using the patient identifier to identify a medication regimen for the patient. The medication regimen may include one or more medications prescribed to the patient and, for each medication, a physical description of the medication, and one or more locations on the personalized medication package where the medication is located. The method may include analyzing the image to identify at least one pill, and for each identified pill, determining one or more physical features of the pill, determining a location of the pill with respect to the personalized medication package, determining whether the determined location of the pill is correct based on the determined physical features and the medication regimen, and in response to determining that the determined location of the pill is not accurate, generating an alert.

In an embodiment, a method of verifying fulfillment of a prescription may include receiving, by a computing device, an image of a personalized medication package associated with a patient, receiving, by the computing device, a patient identifier associated with the patient, and using the patient identifier to identify a medication regimen for the patient. The medication regimen may include one or more medications prescribed to the patient and, for each medication, a physical description of the medication, and one or more locations on the personalized medication package where the medication is located. The method may include analyzing the image to identify one or more compartments of the personalized medication package, for each identified compartment, determining whether a number of pills within the compartment is correct based on the medication regimen; and in response to determining that the number of pills within the compartment is not correct, generating an alert.

In an embodiment, a method of verifying fulfillment of a prescription may include receiving, by a computing device, an image of a personalized medication package associated with a patient, receiving, by the computing device, a patient identifier associated with the patient, and using the patient identifier to identify a medication regimen for the patient. The medication regimen may include one or more medications prescribed to the patient and, for each medication, a physical description of the medication, and one or more locations on the personalized medication package where the medication is located. The method may include analyzing the image to identify one or more compartments of the personalized medication package, and for each identified compartment, determining whether a number of pills within the compartment is correct based on the medication regimen. In response to determining that the number of pills within the compartment is correct, the method may include, for each identified pill within the compartment, determining one or more physical features of the pill, determining a location of the compartment with respect to the personalized medication package, determining whether the pill is correctly located within the compartment based on the determined physical features and the medication regimen, and in response to determining that the pill is incorrectly located within the compartment, generating an alert.

In an embodiment, a system for verifying fulfillment of a prescription may include a computing device and a computer-readable storage medium in communication with the computing device. The computer-readable storage medium may include one or more programming instructions that, when executed, cause the computing device to receive an image of a personalized medication package associated with a patient, receive a patient identifier associated with the patient, and use the patient identifier to identify a medication regimen for the patient. The medication regimen may include one or more medications prescribed to the patient and, for each medication a physical description of the medication, and one or more locations on the personalized medication package where the medication is located. The computer-readable storage medium may include one or more programming instructions that, when executed, cause the computing device to analyze the image to identify at least one pill, and for each identified pill, determine one or more physical features of the pill, determine a location of the pill with respect to the personalized medication package, determine whether the determined location of the pill is correct based on the determined physical features and the medication regimen, and generate an alert in response to determining that the determined location of the pill is not accurate.

### BRIEF DESCRIPTION OF THE DRAWINGS

FIG. 1 illustrates a block diagram of a cloud system according to an embodiment.

FIG. 2 illustrates a flow diagram of an illustrative method of generating a structural document according to an embodiment.

FIGS. 3A-3C illustrate examples of unique location identifiers for compartments of a personalized medication package according to various embodiments.

FIG. 4 illustrates example information that may be stored in a patient storage module according to an embodiment.

FIG. 5 illustrates a flow chart of a method of verifying dispensed medication according to an embodiment.

FIG. 6 illustrates a flow chart of an example method of determining whether one or more discrepancies exist between at least a portion of information from a patient's medication regimen and at least a portion of information from the received image or images according to an embodiment.

FIG. 7 illustrates a block diagram of hardware that may be used to contain or implement program instructions according to an embodiment.

### DETAILED DESCRIPTION

The following terms shall have, for purposes of this application, the respective meanings set forth below:

A “cloud system” refers to one or more physical and/or logical devices that operate as a shared resource for multiple remote print-related devices and/or computing devices.

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

An “imaging device” is an electronic device that is capable of capturing one or more images of a personalized medication package.

A “logical device” is a representation of a physical device that uniquely identifies the corresponding physical device. For example, a network interface may be assigned a unique media access control address that is the logical unique identifier of a physical device. As such, a conventional device is a combined logical and physical device in which the logical device provides the entire identity of the physical device.

A “medication regimen” is one or more medications that a patient is to take over a period of time.

A “patient identifier” is a unique identifier associated with a patient. A patient identifier may be one or more alpha-numeric characters, symbols and/or the like.

A “personalized medication package” is a package for holding a medication regimen for a patient.

A “physical device” is a physical resource such as a computing device, a computer-readable storage medium and/or the like.

The term “remote,” as used herein with respect to computing devices and/or printing devices, refers to devices that operate on different computer networks and/or computer networks operated by different entities. For example, a computing device is remote from a printing device if the computing device is connected to a first LAN operated by a first entity and the printing device is connected to a second LAN operated by a second entity.

A “remote location” is a location physically and/or geographically distant from the location of a computing device. For example, if a computing device associated with a user is a home desktop computer, a remote location may be one that is geographically distant from the user's home.

A “resource” is a physical device comprising a processor and/or a storage medium. Examples of resources may include a computing device, a processing device, a storage device and/or the like.

A “shared resource” is a resource that may be accessed and used by a plurality of other resources.

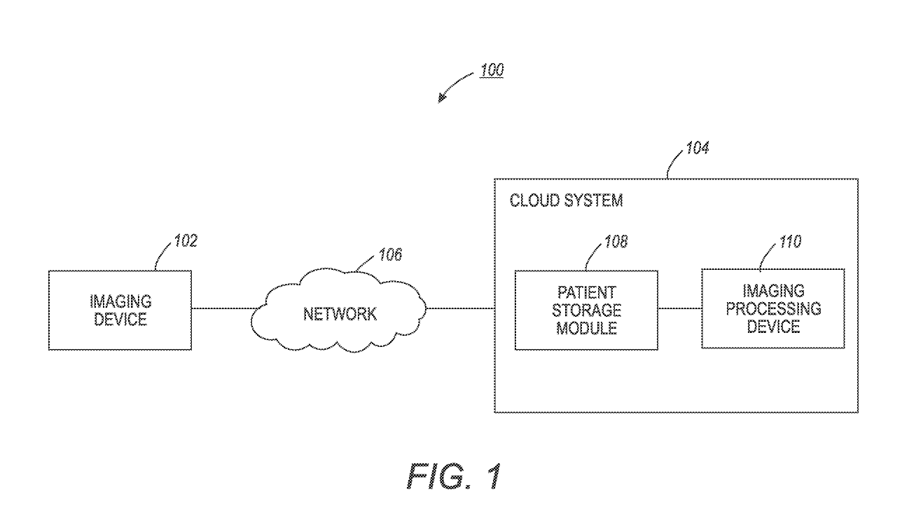

FIG. 1 illustrates a block diagram of a system 100 according to an embodiment. As illustrated by FIG. 1, a system may include an imaging device 102 in communication with a cloud system 104. An imaging device may be a computing device having a camera, a scanner, or other equipment capable of capturing an image. In an embodiment, an imaging device may be a multi-function print device, a xerographic device and/or the like.

In an embodiment, a cloud system may be in communication with an imaging device via a communication network 106. In various embodiments, the communication network 106 may be a local area network (LAN), a wide area network (WAN), a mobile or cellular communication network, an extranet, an intranet, the Internet and/or the like. In an embodiment, the communication network 106 may provide communication capability between an imaging device 102 and the cloud system 104. An imaging device 102 may communicate across the network 106 using any suitable communications protocol. For example, an imaging device 102 may communicate with a cloud system 104 via a wireless connection to a router that is connected to the Internet

In an embodiment, a cloud system may be in communication with one or more storage modules. A storage module may be a computer-readable storage medium capable of storing information. In an embodiment, a storage module may be a database, a table, a list and/or the like. As illustrated by FIG. 1, a cloud system may be in communication with a patient storage module 108. A patient storage module 108 may store information pertaining to one or more medication regimens for one or more patients. For example, a patient storage module may store an identifier associated with a patient, such as the patient's name, social security number, or another unique identifier. The patient storage module may store information about what medications a patient is to take. For example, a patient storage module may store the names of the medication a patient is prescribed, the name of the prescribing physician, a dosing regimen (i.e., a frequency with which the patient is to take a medication) and/or the like. A patient storage module may store a packaging profile associated with a patient's medication regimen. A packaging profile may include a picture or data representing an image of each medication in the patient's medication regimen, a description of the physical appearance of each medication in the patient's medication regimen and/or one or more locations where each medication is expected to be found in a personalized medication package associated with the patient.

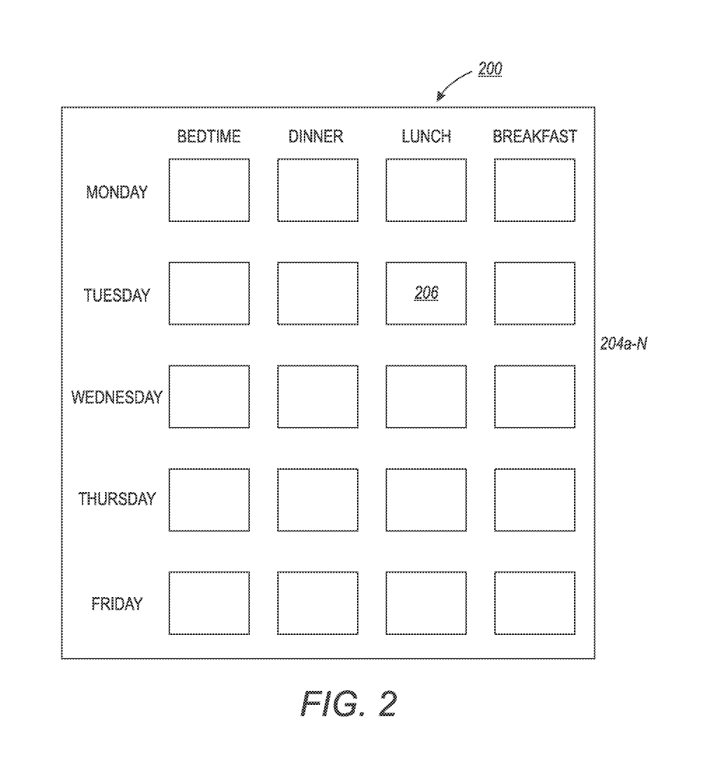

A personalized medication package may be a package for holding a medication regimen for a patient. FIG. 2 illustrates an example of a personalized medication package according to an embodiment. As illustrated by FIG. 2, a personalized medication package 200 may include one or more compartments that each may hold one or more medications. In an embodiment, a medication regimen may be dispensed into one or more compartments of a personalized medication package according to an embodiment. A compartment may be a reservoir, a pocket or other area. For example, a compartment may be a burst packet such as those illustrated by FIG. 2.

In an embodiment, each compartment 202a-N may hold one or more medications 204a-N. For example, each compartment may hold a dosage of one or more medications that a patient is to take on a certain day and time. Each compartment may be associated with a location on the personalized medication package. In an embodiment, a location may correspond to a day and/or a time at which a patient is to take the medication within the burst packet. For example, as illustrated by FIG. 2, a row associated with a compartment may correspond to a day of the week during which the medication in the compartment is to be taken. A column associated with a compartment may correspond to a time of day during which the medication in the compartment is to be taken. For example, the compartment labeled 206 on FIG. 2 is to be taken around lunch on Tuesday. Although FIG. 2 illustrates compartments positioned in a matrix, it is understood that compartments may be positioned in additional and/or alternate arrangements, and that the position of a compartment may reflect the time of day and/or day of the week on which the medication within the compartment is to be taken.

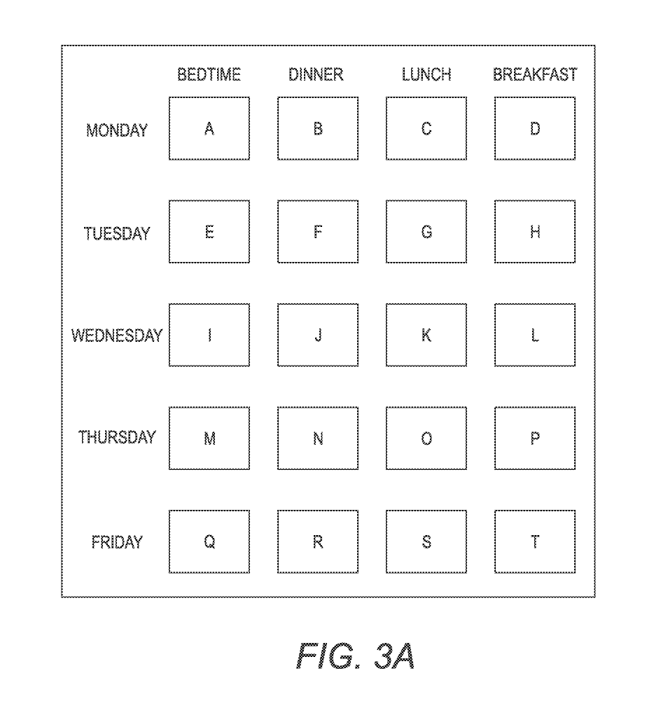

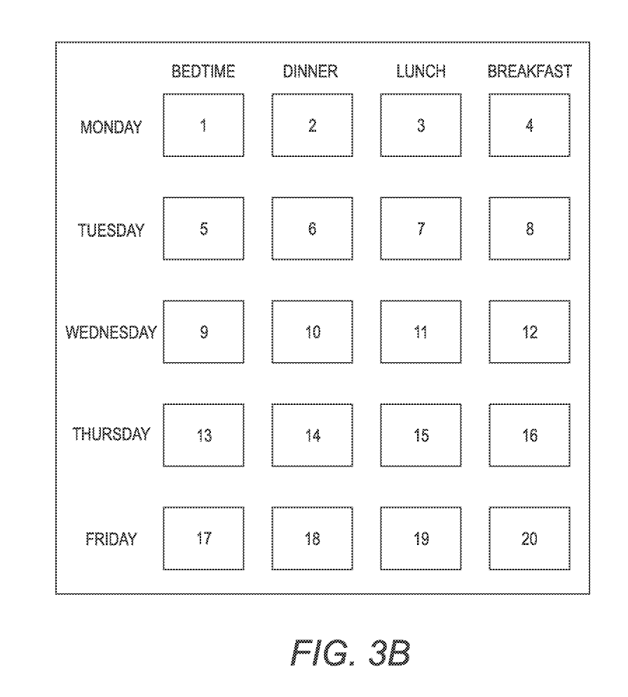

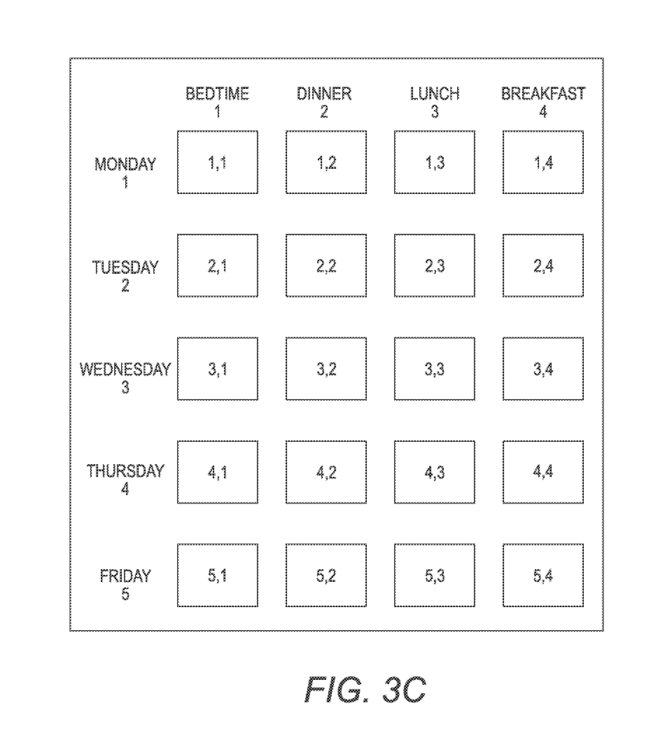

In an embodiment, a location of a compartment may be identified by a unique identifier. A unique identifier may be a number, a letter, a coordinate, or other unique identification. FIGS. 3A-3C illustrate examples of unique location identifiers for compartments of a personalized medication package.

In an embodiment, a personalized medication package may include a medication regimen for a certain period of time. For example, the personalized medication package 200 illustrated in FIG. 2 includes a medication regimen for one week. However, additional and/or alternate time periods, may be used within this disclosure.

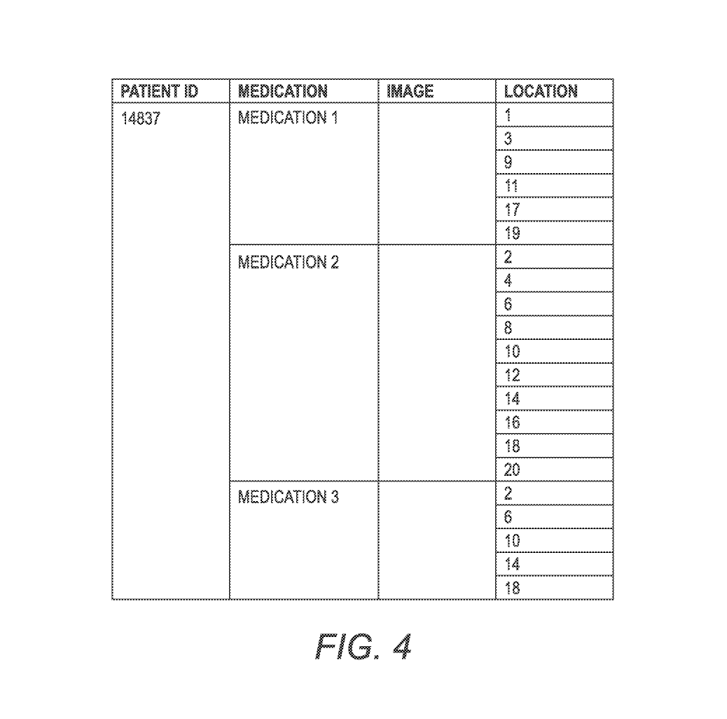

FIG. 4 illustrates example information that may be stored in a patient storage module according to an embodiment. As illustrated by FIG. 4, a patient storage module may store a patient identifier 400 and a packaging profile associated with the patient identifier. The packaging profile includes an image for each distinct medication in the patient's medication regimen and a location of each medication on the personalized medication package. The locations illustrated in FIG. 4 may correspond to the compartment locations shown in FIG. 3C. For example, Medication 1 may be located in the compartments shown in FIG. 3C labeled 1, 3, 9, 11, 17 and 19. As such, the patient is to take Medication 1 two times a day on Monday, Wednesday and Friday at bedtime and lunch.

In an embodiment, a cloud system 104 may include and/or be in communication with an image processing device 110. The image processing device 110 may be a computing device configured to analyze one or more images. An image processing device 110 may be located remotely from an imaging device. In an embodiment, an image processing device 110 may be a server or other type of computing or processing device. An image processing device 110 may be communication with a patient storage module 108 in an embodiment.

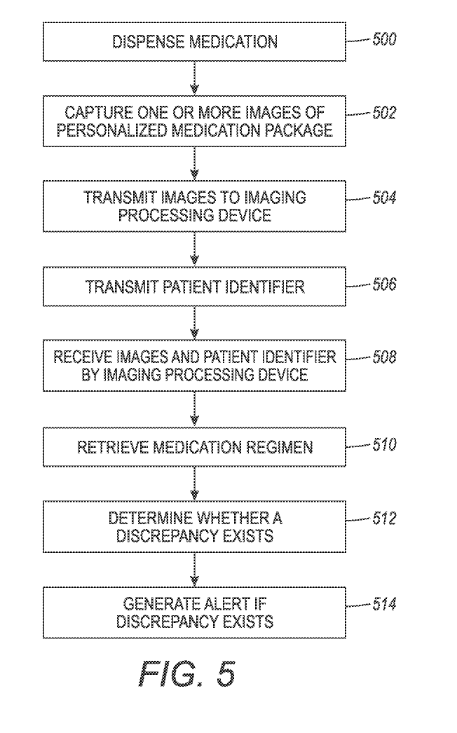

FIG. 5 illustrates a flow chart of a method of verifying dispensed medication according to an embodiment. As illustrated by FIG. 5, medication may be dispensed 500 for a patient. The medication may be dispensed as part of a medication regimen for a patient. A medication regimen may be one or more medications that the patient is to take over a period of time. For example, an example medication regimen may be to take two medications two times a day for two weeks. Additional and/or alternate medication regimens may be used within the scope of this disclosure. In an embodiment, medication that is to be taken pursuant to a medication regimen may be dispensed 500 into a personalized medication package.

In an embodiment, one or more images may be captured 502 of the personalized medication package. An image of at least a portion of the medication within one or more compartments may be taken. In an embodiment, one or more compartments of a personalized medication packet may be formed from substantially transparent material. An imaging device may be used to capture 502 an image of at least a portion of the medication within a personalized medication package. For example, a personalized medication package may be scanned by a multi-function device to generate an image of at least a portion of the medication within the personalized medication package. In another embodiment, a user may use a camera to capture 502 an image of at least a portion of the medication within the personalized medication package. In an embodiment, an image of a personalized medication package may be captured from one or more angles. For example, an image may be captured from above, below, from a side and/or the like of a personalized medication package.

In an embodiment, an imaging device may transmit 504 a data file containing a captured image to an image processing device. An image may be transmitted 504 directly from an imaging device to an image processing device. In another embodiment, an image may be transmitted 504 from an imaging device to an image processing device via one or more computing devices.

In an embodiment, an identifier of a patient associated with a personalized medication package may be transmitted 506 to an image processing device. The patient identifier may identify the patient to which the image or images correspond. In an embodiment, an imaging device may receive an identifier associated with a personalized medication package when it captures an image of the personalized medication package. For example, as illustrated by FIG. 3, a personalized medication package may include an encoded data mark such as, for example, a bar code or a QR code. A patient identifier may be embedded in an encoded data mark. An imaging device may read a patient identifier from an encoded data mark when it captures an image of the personalized medication package. For example, an imaging device may scan a bar code to read a patient identifier embedded in the encoded data mark. Additional and/or alternate methods of reading a patient identifier from an encoded data mark The imaging device may transmit 506 the patient identifier directly to an image processing device or to an image processing device via one or more computing devices.

In an embodiment, an image processing device may receive 508 one or more captured images and a patient identifier associated with the captured images. The image processing device may retrieve 510 a medication regimen from the patient storage module based on the received patient identifier. In an embodiment, the image processing device may determine 512 whether one or more discrepancies exist between at least a portion of information from a patient's medication regimen and at least a portion of information from the received image or images.

In an embodiment, for one or more compartments in the received image or images, the image processing device may perform image analysis to determine the medication or medications within the compartment and determine whether the medication or medications correspond to the patient's dosage for the day and/or time associated with the location of the compartment. The image processing device may determine physically identifying information pertaining to medication in a personalized medication package using image analysis. For example, the image processing device may determine a size, shape, color, markings, scoring and/or the like for each pill or other unit of medication within a compartment of the personalized medication package.

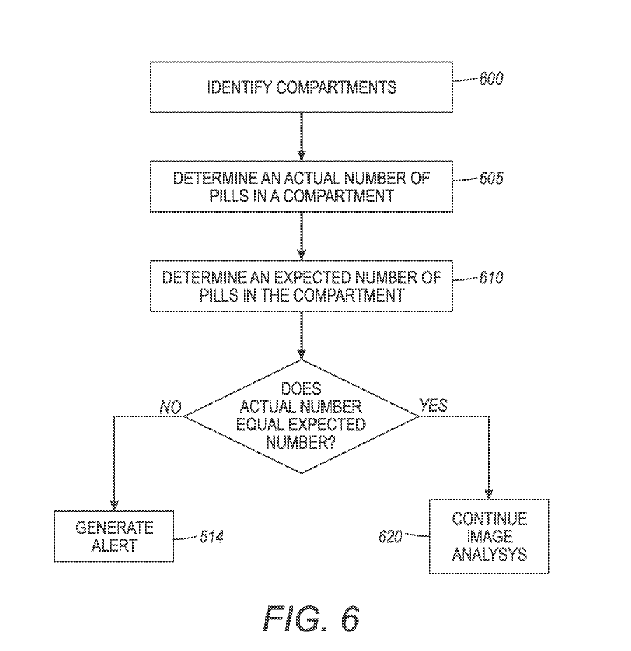

FIG. 6 illustrates a flow chart of an example method of determining whether one or more discrepancies exist between at least a portion of information from a patient's medication regimen and at least a portion of information from the received image or images according to an embodiment. As illustrated by FIG. 6, an image processing device may identify 600 one or more compartments of a personalized medication package from one or more received images. In an embodiment, an actual number of pills and/or type within one or more identified compartments may be determined 605 from one or more received images. For example, an image processing device may perform image analysis on one or more received images to determine an actual number of pills within one or more compartments.

In an embodiment, an expected number of pills associated with the compartment may be determined 610. An expected number of pills for a compartment may be a number of pills that are supposed to be within the compartment according to the patient's medication regimen. In an embodiment, an expected number of pills for a compartment may be determined 610 by identifying a location associated with the compartment, and determining, from the patient's medication regimen, a number of pills that are associated with that location.

In an embodiment, an actual number of pills associated with a compartment may be compared 615 to an expected number of pills for the compartment. If the actual number of pills does not equal the expected number of pills, then an alert may be generated 514. If the actual number of pills does equal the expected number of pills, then the image processing device may continue 620 its image analysis.

In an embodiment, the image processing device may determine whether the medication or medications in a compartment are the ones (i.e., types or categories) that should be there. The image processing device may compare physically identifying information it determines from the image or images to physically identifying information from the patient's medication regimen to determine whether the proper medications are within the compartment. For example, a patient's medication regimen may include taking one pill of Medication A with one pill of Medication B at breakfast on Mondays. Medication A may be a round blue pill having a diameter of approximately 0.5 centimeters. Medication B may be an oval shaped pink pill having a length of approximately 1 centimeter. The image processing device may determine from the received image or images whether the compartment associated with breakfast on Mondays contains one pill of Medication A and one pill of Medication B. If so, the image processing device may continue analyzing other compartments of the personalized medication packet. If not, the image processing device may generate 514 an alert notifying a user or operator of the discrepancy. For example, if the image processing device determines that the compartment contains one round blue pill having a diameter of approximately 0.5 centimeters and one oval shaped purple pill having a length of approximately 1 centimeter, the image processing device may generate 514 an alert. Additional and/or alternate discrepancies may be determined within the scope of this disclosure.

In an embodiment, one or more medications may not be fully visible in a received image or images. For example, a medication may be partially blocked by other medications within a compartment. As another example, a medication may be positioned on its side or in another configuration when an image is captured so that a full image of the medication is not produced. In this situation, the image processing device may compare the images of the medications that are visible with the patient's medication regimen and then determine whether the partially-visible medications are the remaining medications from the medication regimen. For example, Table 1 illustrates an example of a patient's medication regimen at lunch on Wednesday according to an embodiment.

TABLE 1

| Medication | Description | Location |
|---|---|---|
| Medication E | Round tablet, green, diameter | 13 |
| | of approximately 0.5 | |
| | centimeter | |
| Medication F | Oval-shaped capsule, blue, | 13 |
| | length of approximately 1 | |
| | centimeter | |
| Medication G | Oval-shaped tablet, pink, | 13 |
| | length of approximately 0.5 | |
| | centimeters | |

As an example, in an image of the compartment corresponding to lunch on Wednesday (i.e., the compartment labeled ‘13’ in FIG. 3C) Medication E may be positioned on its side and may be partially blocked by Medication F and Medication G. The image processing device may determine whether the other two visible medications are Medication F and Medication G. After determining that the medications from the image correspond to those in the patient's medication regimen, the image processing device may determine whether the physically identifying information it can discern from the image of the partially visible medication matches the physically identifying information associated with Medication E. For example, because the medication is turned on its side, the image processing device may not be able to determine it's size. However, the image processing device may be able to determine its color and general shape. In an embodiment, if an image processing device is able to match at least a portion of physically identifying information from a partially-visible medication to physically identifying information associated with one or more medication from a patient's medication regimen, then the image processing device may not notify a user or operator. Otherwise, the image processing device may generate 514 an alert notifying a user or operator of a potential discrepancy.

In an embodiment, an image processing device may generate 514 an alert if it is not able to match a certain number, percentage or other amount of physically identifiable information from a partially-visible medication. For example, an image processing device may generate 514 an alert if it cannot match more than 50% of the physically identifying information of an image of a partially-visible medication and a patient's medication regimen. Additional and/or alternate measurements may be used within the scope of this disclosure.

In an embodiment, as described above, an image processing device may generate 514 an alert notifying a user or operator if it detects a potential discrepancy. In an embodiment, the image processing device may cause an alert to be displayed at the imaging device from which it received the images of the personalized medication package being analyzed. In another embodiment, the image processing device may cause an alert to be displayed at a computing device associated with a user or operator. The alert may be a message to be displayed on a computing device, such as, for example, a window. In an embodiment, an alert may be sent to a user and/or operator via email, fax, text message and/or the like.

In an embodiment, an alert may include information pertaining to the detected discrepancy, location on the personalized medication package where the discrepancy was detected, a description of the pill that is at issue and/or the like. For example, an alert may include the following information: “An extra round, blue pill was detected in location 10.” As another example, an alert may include the following information: “A potentially incorrect medication was detected in location 5.” As another example, an alert may include the following information: “A pill is missing from location 1.” Additional and/or alternate information may be included in a notification.

In an embodiment, one or more received images may be stored 516. One or more images may be stored 516 at the image processing device or in a computer-readable storage medium in communication with the image processing device. The images may be stored 516 for a certain period of time. For example, images may be stored 516 for a month after which time the images may be deleted. Additional and/or alternate time periods may be used within the scope of this disclosure. In an embodiment, images may be stored 516 for an indefinite amount of time.

In an embodiment, stored images may help a user or operator investigate claims that a medication regimen was improperly dispensed to a personalized medication package. For example, if a patient asserts that his or her personalized medication package contained the incorrect medication, a user or operator may be able to access stored images of the patient's personalized medication package to verify the patient's claims.

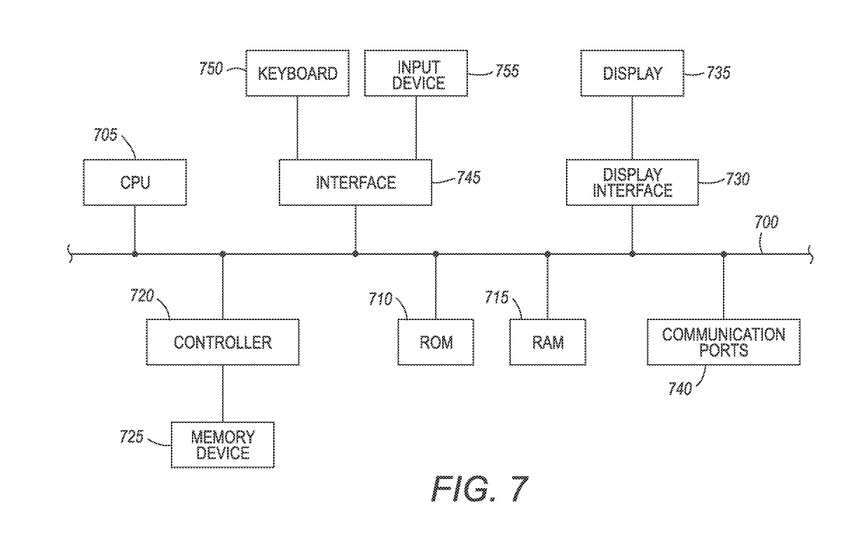

FIG. 7 depicts a block diagram of hardware that may be used to contain or implement program instructions. A bus 700 serves as the main information highway interconnecting the other illustrated components of the hardware. CPU 705 is the central processing unit of the system, performing calculations and logic operations required to execute a program. CPU 705, alone or in conjunction with one or more of the other elements disclosed in FIG. 7, is an example of a processing device, computing device or processor as such terms are used within this disclosure. Read only memory (ROM) 710 and random access memory (RAM) 715 constitute examples of memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 710 and/or the RAM 715. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 730 may permit information from the bus 700 to be displayed on the display 735 in audio, visual, graphic or alphanumeric format. Communication with external devices, such as a printing device, may occur using various communication ports 740. A communication port 740 may be attached to a communications network, such as the Internet or an intranet.

The hardware may also include an interface 745 which allows for receipt of data from input devices such as a keyboard 750 or other input device 755 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of verifying fulfillment of a prescription, the method comprising:
receiving, by a computing device, an image of a personalized medication package associated with a patient;
receiving, by the computing device, a patient identifier associated with the patient;
using the patient identifier to identify a medication regimen for the patient, wherein the medication regimen comprises one or more medications prescribed to the patient and, for each medication:
a physical description of the medication, and
one or more locations on the personalized medication package where the medication is located;
analyzing the image to identify at least one pill; and
for each identified pill:
determining one or more physical features of the pill,
determining a location of the pill with respect to the personalized medication package,
determining whether the determined location of the pill is correct based on the determined physical features and the medication regimen, and
in response to determining that the determined location of the pill is not accurate, generating an alert.

2. The method of claim 1, wherein receiving an image of a personalized medication package associated with a patient comprises receive the image of the personalized medication package from an imaging device.

3. The method of claim 1, wherein receiving a patient identifier associated with the patient comprises receiving a patient identifier that was embedded in an encoded data mark of the personalized medication package.

4. The method of claim 1, wherein determining one or more physical features of the pill comprises determining one or more of the following:
a size of the pill;
a color of the pill;
a shape of the pill;
one or more markings of the pill; and
a scoring of the pill.

5. The method of claim 1, wherein determining a location of the pill with respect to the personalized medication package comprises determining a location of a compartment of the personalized medication package that contains the pill.

6. The method of claim 1, wherein determining whether the determined location of the pill is correct based on the determined physical features and the medication regimen comprises:
identifying the pill as a certain type of medication based on at least a portion of the determined physical features;
determining whether the determined location of the pill matches at least one location associated with the type of medication from the medication regimen; and
in response to the determined location of the pill matching at least one location associated with the type of medication from the medication regimen, determining that the determined location of the pill is correct.

7. The method of claim 1, wherein determining whether the determined location of the pill is correct based on the determined physical features and the medication regimen comprises:
identifying the pill as a certain type of medication based on at least a portion of the determined physical features;
determining whether the determined location of the pill matches at least one location associated with the type of medication from the medication regimen; and
in response to the determined location of the pill not matching at least one location associated with the type of medication from the medication regimen, determining that the determined location of the pill is incorrect.

8. The method of claim 1, wherein generating an alert comprises performing one or more of the following:
causing an alert window to be displayed at a computing device of a user; and
sending an electronic message to a user.

9. The method of claim 1, wherein generating an alert comprises generating an alert comprising one or more of the following:
an indication that the determined location of the pill is not accurate;
the determined location; and
the determined physical features of the pill.

10. The method of claim 1, further comprising storing the received image for a period of time.

11. A method of verifying fulfillment of a prescription, the method comprising:
receiving, by a computing device, an image of a personalized medication package associated with a patient;
receiving, by the computing device, a patient identifier associated with the patient;
using the patient identifier to identify a medication regimen for the patient, wherein the medication regimen comprises one or more medications prescribed to the patient and, for each medication:
a physical description of the medication, and
one or more locations on the personalized medication package where the medication is located;
analyzing the image to identify one or more compartments of the personalized medication package;
for each identified compartment, determining whether a number of pills within the compartment is correct based on the medication regimen; and
in response to determining that the number of pills within the compartment is not correct, generating an alert.

12. The method of claim 11, wherein determining whether a number of pills within the compartment is correct based on the medication regimen comprises:
determining an actual number of pills within the compartment from the image;
determining an expected number of pills within the compartment by using the medication regimen to identify a number of pills of each medication having a location corresponding to the location of the compartment; and
determining that the number of pills within compartment is correct if the actual number of pills equals the expected number of pills.

13. The method of claim 11, wherein determining whether a number of pills within the compartment is correct based on the medication regimen comprises:
determining an actual number of pills within the compartment from the image;
determining an expected number of pills within the compartment by using the medication regimen to identify a number of pills of each medication having a location corresponding to the location of the compartment; and
determining that the number of pills within compartment is incorrect if the actual number of pills does not equal the expected number of pills.

14. A method of verifying fulfillment of a prescription, the method comprising:
receiving, by a computing device, an image of a personalized medication package associated with a patient;
receiving, by the computing device, a patient identifier associated with the patient;
using the patient identifier to identify a medication regimen for the patient, wherein the medication regimen comprises one or more medications prescribed to the patient and, for each medication:
a physical description of the medication, and
one or more locations on the personalized medication package where the medication is located;
analyzing the image to identify one or more compartments of the personalized medication package;
for each identified compartment, determining whether a number of pills within the compartment is correct based on the medication regimen; and
in response to determining that the number of pills within the compartment is correct, for each identified pill within the compartment:
determining one or more physical features of the pill,
determining a location of the compartment with respect to the personalized medication package,
determining whether the pill is correctly located within the compartment based on the determined physical features and the medication regimen, and
in response to determining that the pill is incorrectly located within the compartment, generating an alert.

15. The method of claim 14, wherein determining whether a number of pills within the compartment is correct based on the medication regimen comprises:
determining an actual number of pills within the compartment from the image;
determining an expected number of pills within the compartment by using the medication regimen to identify a number of pills of each medication having a location corresponding to the location of the compartment; and
determining that the number of pills within compartment is correct if the actual number of pills equals the expected number of pills.

16. The method of claim 14, wherein determining whether the pill is correctly located within the compartment comprises:
identifying the pill as a certain type of medication based on at least a portion of the determined physical features;
determining whether the determined location of the pill matches at least one location associated with the type of medication from the medication regimen; and
in response to the determined location of the pill matching at least one location associated with the type of medication from the medication regimen, determining that the determined location of the pill is correct.

17. The method of claim 14, wherein determining whether the pill is correctly located within the compartment comprises:
identifying the pill as a certain type of medication based on at least a portion of the determined physical features;
determining whether the determined location of the pill matches at least one location associated with the type of medication from the medication regimen; and
in response to the determined location of the pill not matching at least one location associated with the type of medication from the medication regimen, determining that the determined location of the pill is incorrect.

18. A system for verifying fulfillment of a prescription, the system comprising:
a computing device; and
a computer-readable storage medium in communication with the computing device, wherein the computer-readable storage medium comprises one or more programming instructions that, when executed, cause the computing device to:
receive an image of a personalized medication package associated with a patient,
receive a patient identifier associated with the patient,
use the patient identifier to identify a medication regimen for the patient, wherein the medication regimen comprises one or more medications prescribed to the patient and, for each medication:
a physical description of the medication, and
one or more locations on the personalized medication package where the medication is located,
analyze the image to identify at least one pill, and
for each identified pill:
determine one or more physical features of the pill,
determine a location of the pill with respect to the personalized medication package,
determine whether the determined location of the pill is correct based on the determined physical features and the medication regimen, and
generate an alert in response to determining that the determined location of the pill is not accurate.

19. The system of claim 18, wherein the one or more programming instructions that, when executed, cause the computing device to determine whether the determined location of the pill is correct based on the determined physical features and the medication regimen comprise one or more programming instructions that, when executed, cause the computing device to:
identify the pill as a certain type of medication based on at least a portion of the determined physical features;
determine whether the determined location of the pill matches at least one location associated with the type of medication from the medication regimen; and
in response to the determined location of the pill matching at least one location associated with the type of medication from the medication regimen, determine that the determined location of the pill is correct.

20. The system of claim 18, wherein the one or more programming instructions that, when executed, cause the computing device to determine whether the determined location of the pill is correct based on the determined physical features and the medication regimen comprise one or more programming instructions that, when executed, cause the computing device to:
identify the pill as a certain type of medication based on at least a portion of the determined physical features;
determine whether the determined location of the pill matches at least one location associated with the type of medication from the medication regimen; and
in response to the determined location of the pill not matching at least one location associated with the type of medication from the medication regimen, determine that the determined location of the pill is incorrect.
